(19) United States
(12) Patent Application Publication
(10) Pub. No.: US 2024/0186633 A1
(43) Pub. Date: Jun. 6, 2024

(54) POWER STORAGE DEVICE

(71) Applicant: TOYOTA JIDOSHA KABUSHIKI KAISHA, Toyota-shi (JP)

(72) Inventors: Shinya GOITSUKA, Nisshin-shi (JP); Shigeyuki INOUE, Toyota-shi (JP)

(73) Assignee: TOYOTA JIDOSHA KABUSHIKI KAISHA, Toyota-shi (JP)

(21) Appl. No.: 18/485,438

(22) Filed: Oct. 12, 2023

(30) Foreign Application Priority Data
Dec. 1, 2022 (JP) 2022-192994

(51) Int. Cl. H01M 50/242; H01M 50/209; H01M 50/291

(52) U.S. Cl. CPC H01M 50/242; H01M 50/209; H01M 50/291

(57) ABSTRACT

A power storage device includes: at least one power storage module including a power storage stack including a plurality of power storage cells arranged in a row along one direction, and a pair of end plates; a frame arranged on opposite sides of the power storage module in the one direction; a cross member arranged adjacent to the power storage module in an orthogonal direction and having a shape to extend along the one direction; and a connecting member connecting the frame to the cross member and connecting the frame to the end plate.

### CROSS REFERENCE TO RELATED APPLICATIONS

This nonprovisional application is based on Japanese Patent Application No. 2022-192994 filed on Dec. 1, 2022 with the Japan Patent Office, the entire contents of which are hereby incorporated by reference.

### BACKGROUND OF THE DISCLOSURE

### Field

The present disclosure relates to a power storage device.

### Description of the Background Art

Conventionally, power storage devices mounted in vehicles or the like have been known. For example, Japanese Patent Laying-Open No. 2021-172136 discloses a battery pack including a plurality of battery modules, and a tray and a cover for housing the plurality of battery modules. Each battery module has a battery stack formed of a stacked component in which a plurality of battery cells are stacked, and a pair of end plates fixed to the opposite sides of the battery stack. The plurality of battery cells are arranged in a row along the width direction of the vehicle. The plurality of battery modules are arranged in a row along the longitudinal direction of the vehicle. The tray has a bottom plate, four side plates surrounding the plurality of battery modules, and a battery cross member arranged between the pair of battery modules adjacent to each other in the longitudinal direction. The battery cross member has a shape to extend in the width direction and is connected to a side plate arranged on the right in the width direction and a side plate arranged on the left in the width direction.

### SUMMARY

The battery pack as disclosed in Japanese Patent Laying-Open No. 2021-172136 is required to have many power storage cells mounted therein, which needs a reduction in crash stroke (a stroke for absorbing an impact load without damage to the power storage cells) upon application of an impact load in the direction in which the power storage cells are arranged. The strength of the cross member or the like needs to be increased for a reduced crash stroke, increasing a vehicle size.

It is an object of the present disclosure to provide a power storage device that can reduce a crash stroke while avoiding an increase in vehicle size.

A power storage device according to one aspect of the present disclosure includes: at least one power storage module including a power storage stack including a plurality of power storage cells arranged in a row along one direction, and a pair of end plates arranged on opposite sides of the power storage stack in the one direction; a frame arranged on opposite sides of the at least one power storage module in the one direction; a cross member arranged adjacent to the at least one power storage module in an orthogonal direction orthogonal to both the one direction and a vertical direction, the cross member having a shape to extend along the one direction; and a connecting member connecting the frame to the cross member and connecting the frame to one of the pair of end plates.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is an exploded perspective view schematically showing part of a configuration of a power storage device according to one embodiment of the present disclosure.

FIG. 2 is a perspective view of a power storage module.

FIG. 3 is a perspective view showing a state before the power storage module is fixed to a case.

FIG. 4 is a perspective view showing a state in which the power storage module is fixed to the case.

FIG. 5 is a sectional view taken along V-V in FIG. 4.

FIG. 6 schematically shows a variation of a connecting member.

### DESCRIPTION OF THE PREFERRED EMBODIMENTS

An embodiment of the present disclosure will be described with reference to the drawings. In the drawings referred to below, the same or corresponding members are denoted by the same reference numerals.

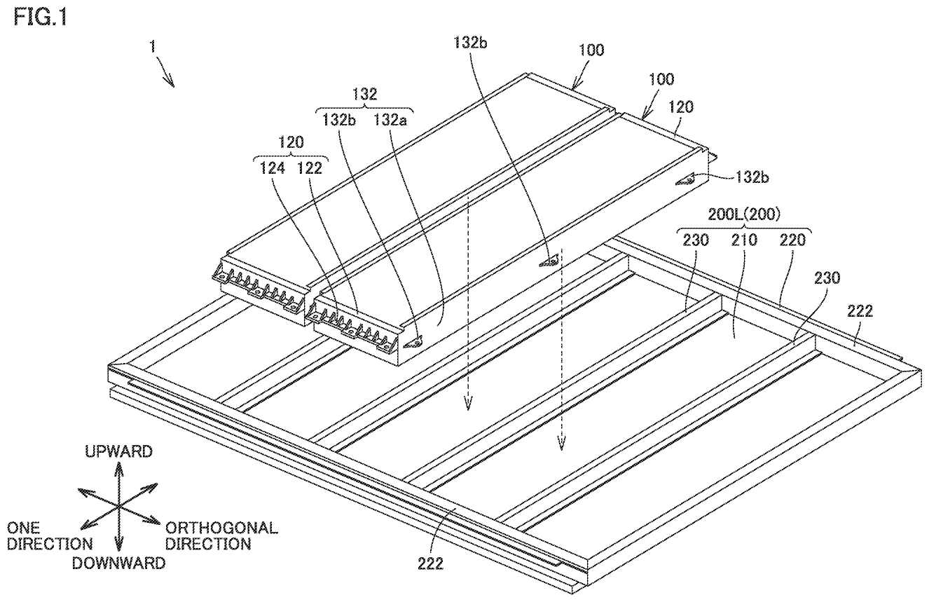

FIG. 1 is an exploded perspective view schematically showing part of a configuration of a power storage device according to one embodiment of the present disclosure. A power storage device 1 is mounted in, for example, a vehicle such as a battery electric vehicle.

As shown in FIG. 1, power storage device 1 includes a plurality of power storage modules 100, a case 200, and a connecting member 300. FIG. 1 shows only two power storage modules 100. Power storage device 1 may include a single power storage module 100.

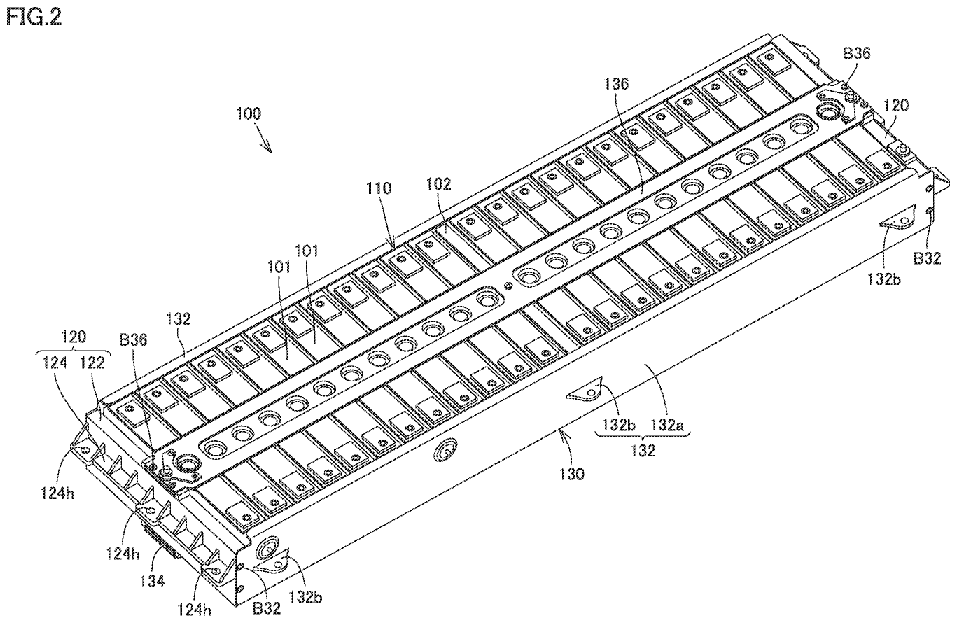

As shown in FIG. 2, each power storage module 100 has a power storage stack 110, a pair of end plates 120, and a restraint band 130.

Power storage stack 110 includes a plurality of power storage cells 101 arranged in a row along one direction. In the present embodiment, power storage stack 110 includes 24 power storage cells 101. However, the number of power storage cells 101 is not limited thereto. Each power storage cell 101 may be, for example, a lithium-ion battery. Each power storage cell 101 has a rectangular parallelepiped shape. Each power storage cell 101 has a flat shape. As shown in FIG. 1, power storage modules 100 are arranged in a row in the orthogonal direction orthogonal to both the one direction and the vertical direction.

In the present embodiment, power storage stack 110 has an intermediate plate 102. Intermediate plate 102 is arranged between a pair of power storage cells 101 arranged at the center among power storage cells 101. Specifically, power storage stack 110 has 12 power storage cells 101 arranged on one side of intermediate plate 102 and 12 power storage cells 101 arranged on the other side of intermediate plate 102.

The pair of end plates 120 are arranged on the opposite sides of power storage stack 110 in the one direction. Each end plate 120 is made of metal (e.g., aluminum). As shown in FIGS. 2 to 5, each end plate 120 has a plate body 122 and a protrusion 124.

Plate body 122 faces power storage stack 110 in the one direction. Plate body 122 has a substantially flat plate shape.

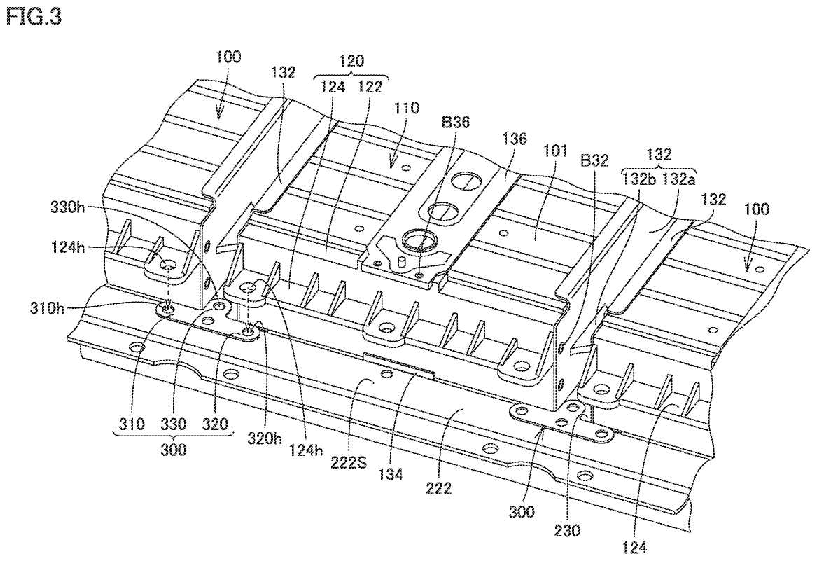

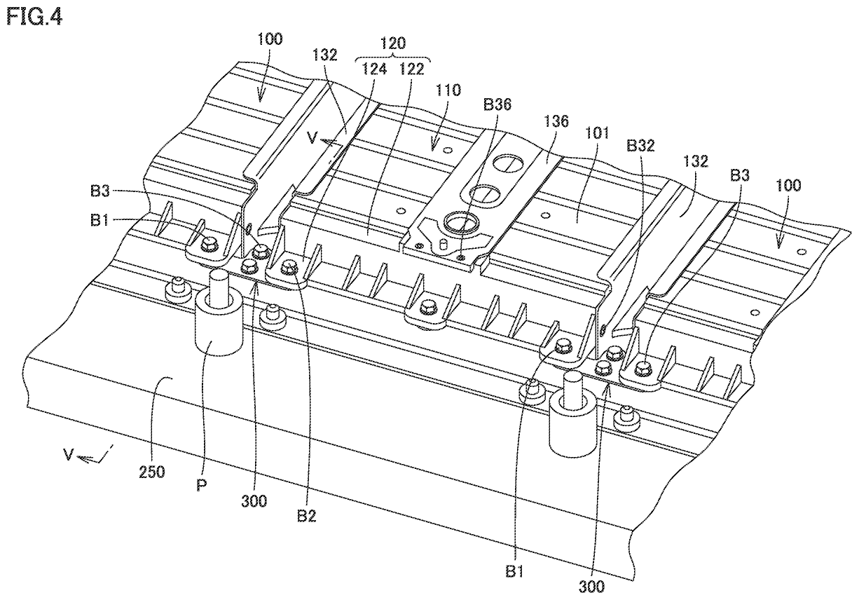

Protrusion 124 has a shape to protrude outwardly in the one direction from plate body 122. As shown in FIGS. 2 and 3, protrusion 124 has insertion holes 124h that allow insertion of fastening members B1 (see FIG. 4), such as bolts, therethrough.

Restraint band 130 restrains power storage stack 110 from the opposite sides in the one direction. As shown in FIGS. 2 to 4, restraint band 130 has a pair of side restraint portions 132, a lower restraint portion 134, and an upper restraint portion 136.

Each side restraint portion 132 is arranged lateral to power storage stack 110 in the orthogonal direction. Each side restraint portion 132 is made of metal or the like. As shown in FIGS. 1 and 2, each side restraint portion 132 has a restraint body 132a and a flange 132b.

Restraint body 132a restrains power storage stack 110 from the opposite sides in the one direction. Restraint body 132a has a shape to extend from one end to the other end of power storage stack 110 in the one direction. Restraint body 132a has a flat plate shape. Restraint body 132a covers a side portion of power storage stack 110 in the orthogonal direction. An insulating sheet may be arranged between restraint body 132a and power storage stack 110. As shown in FIGS. 2 to 5, restraint body 132a is connected to a side surface of plate body 122 by fastening members B32.

As shown in FIGS. 1 and 2, flange 132b has a shape to project outwardly in the orthogonal direction from restraint body 132a. Flange 132b is connected to a cross member 230, which will be described later.

Lower restraint portion 134 is arranged below power storage stack 110 and restrains power storage stack 110 from the opposite sides in the one direction. Lower restraint portion 134 has a shape to extend from one end to the other end of power storage stack 110 in the one direction. Lower restraint portion 134 is arranged below power storage stack 110 and at the center of power storage stack 110 in the orthogonal direction. Lower restraint portion 134 is made of metal or the like. An insulating sheet may be arranged between lower restraint portion 134 and the lower surface of power storage stack 110. Lower restraint portion 134 is connected to the lower surface of plate body 122 by a fastening member (not shown).

Upper restraint portion 136 is arranged above power storage stack 110 and restrains power storage stack 110 from the opposite sides in the one direction. Upper restraint portion 136 has a shape to extend from one end to the other end of power storage stack 110 in the one direction. Upper restraint portion 136 is arranged above power storage stack 110 and at the center of power storage stack 110 in the orthogonal direction. Upper restraint portion 136 is provided with an exposure port for exposing a pressure release valve of each power storage cell 101. Upper restraint portion 136 is made of metal or the like. An insulating sheet may be arranged between upper restraint portion 136 and the lower surface of power storage stack 110. As shown in FIGS. 2 and 3, upper restraint portion 136 is connected to the upper surface of plate body 122 by fastening members B36.

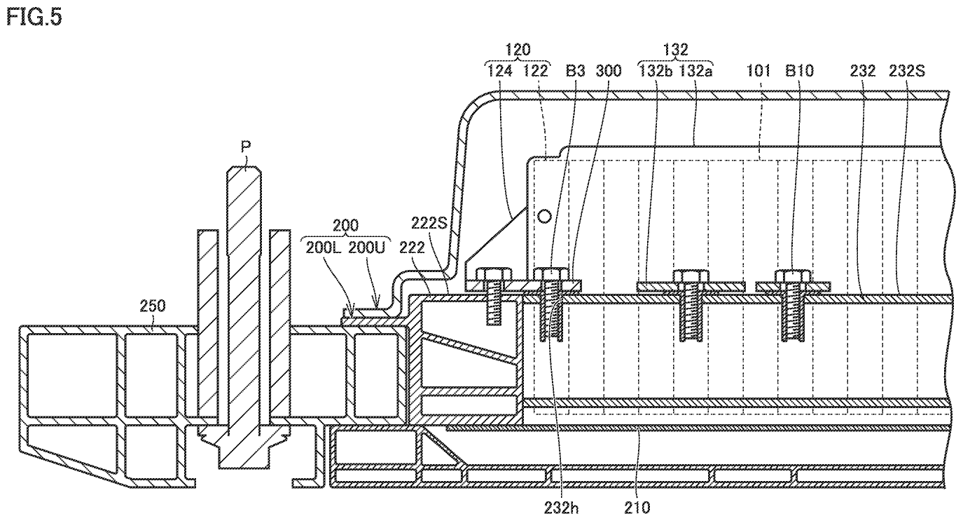

Case 200 houses power storage modules 100. Case 200 has a lower case 200L and an upper case 200U (see FIG. 5). In FIG. 1, upper case 200U is not shown.

Lower case 200L is shaped to be open upward. Lower case 200L is made of a metal such as aluminum. Lower case 200L has a bottom wall 210, a peripheral wall 220, and cross member 230.

Bottom wall 210 supports power storage modules 100 from below. Bottom wall 210 may have a flat plate shape.

Peripheral wall 220 rises from the peripheral portion of bottom wall 210 and surrounds power storage modules 100. Peripheral wall 220 includes a frame 222.

Frame 222 is arranged on the opposite sides of power storage module 100 in the one direction. Frame 222 has a shape to extend in the orthogonal direction. As shown in FIG. 5, frame 222 is formed such that its cross-section forms a closed cross-section. Frame 222 is formed by, for example, extrusion of aluminum. Frame 222 may be fixed to bottom wall 210 by welding, fastening, or the like. An upper surface 222S of frame 222 is formed to be flat.

Cross member 230 is arranged adjacent to power storage module 100 in the orthogonal direction. Cross member 230 has a shape to extend along the one direction. As shown in FIG. 1, cross member 230 partitions a pair of power storage modules 100 adjacent to each other in the orthogonal direction. As shown in FIG. 5, the opposite ends of cross member 230 in the one direction are in contact with the inner side surface of frame 222. In other words, cross member 230 has a function of reinforcing frame 222.

As shown in FIG. 5, cross member 230 has an upper wall 232. Upper wall 232 has an upper surface 232S formed to be flush with upper surface 222S of frame 222. As shown in FIG. 5, flange 132b of side restraint portion 132 is connected to upper wall 232 by a fastening member B10. At the end of upper wall 232 in the one direction, an insertion hole 232h that allows insertion of a fastening member B3 therethrough is formed.

Connecting member 300 connects frame 222 to cross member 230 and connects frame 222 to end plate 120. Connecting member 300 connects end plate 120 of each of the pair of power storage modules 100, adjacent to each other in the orthogonal direction, to frame 222. As shown in FIG. 3, connecting member 300 has a first arm 310, a second arm 320, and a cross connecting portion 330.

First arm 310 connects protrusion 124 of end plate 120 in one power storage module 100 of a pair of adjacent power storage modules 100 to frame 222. First arm 310 has a shape to extend in the orthogonal direction. As shown in FIG. 3, first arm 310 is provided with an insertion hole 310h that allows insertion of fastening member B1 (see FIG. 4) therethrough. Fastening member B1 is fixed to frame 222 while being inserted through insertion hole 124h formed in protrusion 124 and insertion hole 310h formed in first arm 310.

Second arm 320 connects protrusion 124 of end plate 120 in the other power storage module 100 of the pair of adjacent power storage modules 100 to frame 222. Second arm 320 has a shape to extend in the orthogonal direction. As shown in FIG. 3, second arm 320 is provided with an insertion hole 320h that allows insertion of a fastening member B2 (see FIG. 4) therethrough. Fastening member B2 is fixed to frame 222 while being inserted through insertion hole 124h formed in protrusion 124 and insertion hole 320h formed in second arm 320.

Cross connecting portion 330 connects cross member 230 to frame 222. Cross connecting portion 330 is formed between first arm 310 and second arm 320. Cross connecting portion 330 has a shape to extend in the one direction. Cross connecting portion 330, first arm 310, and second arm 320 are formed in the same plane. First arm 310, second arm 320, and cross connecting portion 330 are formed in a substantially T shape. As shown in FIG. 3, cross connecting portion 330 is provided with an insertion hole 330h that allows insertion of fastening member B3 (see FIGS. 4 and 5) therethrough. Fastening member B3 is fixed to upper wall 232 of cross member 230 while being inserted through insertion hole 330h formed in cross connecting portion 330 and insertion hole 232h (see FIG. 5) formed in upper wall 232 of cross member 230.

In power storage device 1 described above, upon application of an impact load to frame 222 from a pole P (see FIGS. 4 and 5) provided in a structure 250 arranged outside frame 222 in the one direction, connecting member 300 transfers the impact load to cross member 230 and end plate 120. Specifically, the impact load is transferred via cross connecting portion 330 to cross member 230 and is transferred via first arm 310 and second arm 320 to end plate 120 of each power storage module 100. The load transferred to end plate 120 is transferred to restraint band 130. In other words, in power storage device 1, cross member 230 and power storage module 100 receive the impact load, reducing a crash stroke. Thus, the number of mounted power storage cells 101 can be increased while avoiding an increase in vehicle size.

In the embodiment above, since flange 132b of side restraint portion 132 is connected to cross connecting portion 330, the impact load transferred via cross connecting portion 330 to cross member 230 is transferred via flange 132b to restraint body 132a. When cross member 230 and side restraint portion 132 can receive the impact load, connecting member 300 may include only cross connecting portion 330.

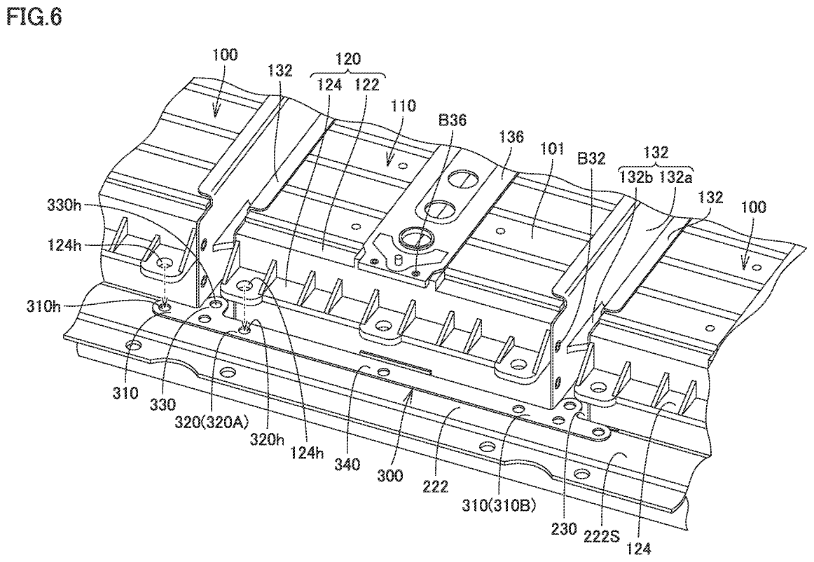

In the embodiment above, connecting members 300 may be coupled to each other. For example, as shown in FIG. 6, connecting member 300 may have a coupling portion 340 that couples second arm 320 (denoted as “320A” in FIG. 6) arranged on one side of one power storage module 100 in the orthogonal direction to first arm 310 (denoted as “310B” in FIG. 6) arranged on the other side of the one power storage module 100 in the orthogonal direction.

It will be appreciated by a person skilled in the art that the exemplary embodiment described above is a specific example of the following aspects.

[Aspect 1]

A power storage device comprising:
at least one power storage module including
   a power storage stack including a plurality of power storage cells arranged in a row along one direction, and
   a pair of end plates arranged on opposite sides of the power storage stack in the one direction;
a frame arranged on opposite sides of the at least one power storage module in the one direction;
a cross member arranged adjacent to the at least one power storage module in an orthogonal direction orthogonal to both the one direction and a vertical direction, the cross member having a shape to extend along the one direction; and
a connecting member connecting the frame to the cross member and connecting the frame to one of the pair of end plates.

In this power storage device, when an impact load is applied outwardly in a direction (the one direction) in which the power storage cells are arranged in a row, the connecting member transfers the impact load to the cross member and the end plate. In other words, in this power storage device, the cross member and the power storage module receive the impact load, reducing a crash stroke.

[Aspect 2]

The power storage device according to aspect 1, wherein
the at least one power storage module includes a pair of power storage modules positioned so as to sandwich the cross member therebetween in the orthogonal direction, and
the connecting member connects one of the pair of end plates of each of the pair of power storage modules to the frame.

In this aspect, a path for transferring the impact load increases, further reducing a crash stroke.

[Aspect 3]

The power storage device according to aspect 2, wherein
each of the pair of power storage modules further includes a restraint band that restrains the power storage stack from opposite sides in the one direction, and
the restraint band is connected to the pair of end plates.

In this aspect, the impact load applied to the frame is transferred via the connecting member and the end plate to the restraint band. In other words, since the restraint band in the power storage module mainly receives the impact load, a crash stroke can be reduced while suppressing transfer of the impact load to each power storage cell.

[Aspect 4]

The power storage device according to aspect 3, wherein
each of the pair of end plates includes
   a plate body facing the power storage stack in the one direction, and
   a protrusion having a shape to protrude outwardly in the one direction from the plate body,
the connecting member connects the protrusion to the frame, and
the restraint band is connected to the plate body.

[Aspect 5]

The power storage device according to aspect 4, wherein the connecting member includes
a first arm connecting the protrusion of one of the pair of end plates in one power storage module of the pair of power storage modules to the frame,
a second arm connecting the protrusion of one of the pair of end plates in another power storage module of the pair of power storage modules to the frame, and
a cross connecting portion formed between the first arm and the second arm and connecting the cross member to the frame.

[Aspect 6]

The power storage device according to aspect 5, wherein
the cross member has an upper surface formed to be flush with the frame, and
the cross connecting portion, the first arm, and the second arm are formed in an identical plane.

Although an embodiment of the present disclosure has been described, it should be understood that the embodiment disclosed herein is illustrative and non-restrictive in every respect. The scope of the present disclosure is defined by the terms of the claims and is intended to include any modifications within the scope and meaning equivalent to the terms of the claims.

What is claimed is:

1. A power storage device comprising:
at least one power storage module including
a power storage stack including a plurality of power storage cells arranged in a row along one direction, and
a pair of end plates arranged on opposite sides of the power storage stack in the one direction;
a frame arranged on opposite sides of the at least one power storage module in the one direction;
a cross member arranged adjacent to the at least one power storage module in an orthogonal direction orthogonal to both the one direction and a vertical direction, the cross member having a shape to extend along the one direction; and
a connecting member connecting the frame to the cross member and connecting the frame to one of the pair of end plates.

2. The power storage device according to claim 1, wherein
the at least one power storage module includes a pair of power storage modules positioned so as to sandwich the cross member therebetween in the orthogonal direction, and
the connecting member connects one of the pair of end plates of each of the pair of power storage modules to the frame.

3. The power storage device according to claim 2, wherein
each of the pair of power storage modules further includes a restraint band that restrains the power storage stack from opposite sides in the one direction, and
the restraint band is connected to the pair of end plates.

4. The power storage device according to claim 3, wherein
each of the pair of end plates includes
a plate body facing the power storage stack in the one direction, and
a protrusion having a shape to protrude outwardly in the one direction from the plate body,
the connecting member connects the protrusion to the frame, and
the restraint band is connected to the plate body.

5. The power storage device according to claim 4, wherein the connecting member includes
a first arm connecting the protrusion of one of the pair of end plates in one power storage module of the pair of power storage modules to the frame,
a second arm connecting the protrusion of one of the pair of end plates in another power storage module of the pair of power storage modules to the frame, and
a cross connecting portion formed between the first arm and the second arm and connecting the cross member to the frame.

6. The power storage device according to claim 5, wherein
the cross member has an upper surface formed to be flush with the frame, and
the cross connecting portion, the first arm, and the second arm are formed in an identical plane.
